(19) United States
(12) Patent Application Publication
(10) Pub. No.: US 2019/0186833 A1
(43) Pub. Date: Jun. 20, 2019

(54) FORCED AIR APPARATUS

(71) Applicant: Rodney SKIFFINGTON, Edmonton (CA)

(72) Inventor: Rodney SKIFFINGTON, Edmonton (CA)

(21) Appl. No.: 16/220,378

(22) Filed: Dec. 14, 2018

(30) Foreign Application Priority Data
Dec. 14, 2017 (CA) 2 988 859

(51) Int. Cl. F26B 9/00; F24F 11/62; D06F 59/02; A47L 23/20; F26B 21/00; F26B 21/06

(52) U.S. Cl. CPC F26B 9/003; F24F 11/62; D06F 59/02; A41D 13/0025; F26B 21/001; F26B 21/06; A47L 23/205

(57) ABSTRACT

A forced air apparatus has an air blower, an air conduit and a diffusion body. The air blower has an air intake, an air outlet and a blower motor. The air conduit has a first end and a second end. The first end is connectable to the air outlet of the air blower. The diffusion body has an air conduit connection and at least one air outlet. The air conduit connection allows for removable connection of the second end of the air conduit to the diffusion body such that air flows from the air blower to the diffusion body. The at least one air outlet allows air to flow out of the diffusion body

### FIELD OF THE DISCLOSURE

The present application relates generally to a forced air apparatus for removing moisture, more specifically it relates to a forced air apparatus for removing moisture, adding decontaminating scents and increasing temperature.

### BACKGROUND

This section provides background information to facilitate a better understanding of the various aspects of the invention. It should be understood that the statements in this section of this document are to be read in this light, and not as admissions of prior art.

Sports bags and gym bags often end up with a smell to them due to the sweaty or wet clothing and items that are stored in them on a regular basis. Clothing and other items stored in these bags may not dry fully between uses and as a result may end up with an odor or bacterial growth. This may require washing of the clothing and other items, as well as the bag, on a regular basis to control odor and bacterial growth. Washing of the bag may be difficult depending upon the material the bag is made from and the type of hardware on the bag. Having a way to dry the contents of the bag and treat for odor and bacterial growth without requiring removal of the contents from the bag would be beneficial.

In areas with cold or wet weather conditions, it is common to end up with wet footwear, gloves and clothing. In addition to taking time to dry, it is common for the drying and dried footwear, gloves and clothing to give off an odor. The ability to quickly and efficiently dry these items could result in less odor and bacterial growth inside the footwear.

Natural disasters such as tsunamis, hurricanes, earthquakes and tornados can have devastating effects on the people who live through them. Disaster relief efforts often include finding appropriate shelters to keep people warm and dry in an attempt to alleviate some of the hardships that are faced following these disasters. Having a system that can create a warm and dry environment could be beneficial. This same type of system could be enjoyed by outdoor enthusiasts who utilize tents.

### BRIEF SUMMARY

There is provided a forced air apparatus. The forced air apparatus has an air blower, an air conduit and a diffusion body. The air blower has an air intake, an air outlet and a blower motor. An air conduit is provided that has a first end and a second end with the first end being connectable to the air outlet of the air blower. The diffusion body has an air conduit connection and at least one air outlet. The air conduit connection allows for removable connection of the second end of the air conduit to the diffusion body such that air flows from the air blower to the diffusion body. The at least one air outlet allows air to flow out of the diffusion body.

In one embodiment, the air blower has a treatment compartment for holding a material to treat the air flowing through the air blower. Material to treat the air may be used for odor control, odor elimination or bacteria elimination.

In one embodiment, the air blower has a timer for managing the amount of time the blower motor is running. The timer may automatically shut off the blower motor after a predetermined amount of time or may elicit an audible signal to inform the user of the predetermined amount of time.

In one embodiment, the air blower has a pressure channel to direct air to travel from the blower motor to the treatment compartment prior to the air flowing through the air outlet.

In one embodiment, the blower motor is electric and requires a power source. In one embodiment, the power source is a rechargeable battery. In another embodiment, the power source is AC power.

In one embodiment, the air blower heats the air as it passes from the air intake to the air outlet.

In one embodiment, the diffusion body is a diffusion mat. The diffusion mat has a first surface, a second surface, a plurality of air outlets and an air conduit connection. The plurality of air outlets allows air flow between the first surface and the second surface such that air flows from the air conduit to the second surface of the diffusion mat.

In another embodiment, the diffusion body is a diffusion hanger. The diffusion hanger is shaped like a clothing hanger and has a plurality of air outlets. The diffusion mat may be used within bags or suitcases or may also be useful as a bed warmer or drying mat.

In one embodiment, the air conduit used in association with the diffusion hanger is rigid and has a plurality of air outlets to allow air to flow out of the air conduit to act upon material draped over the diffusion hanger.

In another embodiment, the diffusion body is a diffusion ball with a plurality of air outlets. The diffusion balls may be useful for the drying of shoes, socks, gloves and other items into which the diffusion balls may fit.

In one embodiment, at least one diffusion ball is supported by a rigid air conduit on a hollow base. The hollow base has an air conduit connection for connecting the air conduit to the hollow base.

In another embodiment, the diffusion body is shaped such that it correlates to an interior surface of a sports helmet. This shape of diffusion body may be used with sports helmets and other headgear.

In one embodiment, the air conduit used in association with the diffusion body shaped to correlate to an interior surface of a sports helmet is rigid to provide support to the diffusion body.

### BRIEF DESCRIPTION OF THE DRAWINGS

These and other features will become more apparent from the following description in which references are made to the following drawings, in which numerical references denote like parts. The drawings are for the purpose of illustration only and are not intended to in any way limit the scope of the invention to the particular embodiments shown.

FIG. 1 is a side elevation view, in section, of the air blower.

FIG. 2 is a perspective view of the forced air apparatus with a diffusion mat.

FIG. 3 is a perspective view of the forced air apparatus with a diffusion hanger.

FIG. 4 is a perspective view of the forced air apparatus with diffusion balls.

FIG. 5 is a perspective view of the forced air apparatus with a diffusion body shaped to correlate to an interior surface of a sports helmet.

### DETAILED DESCRIPTION OF THE PREFERRED EMBODIMENTS

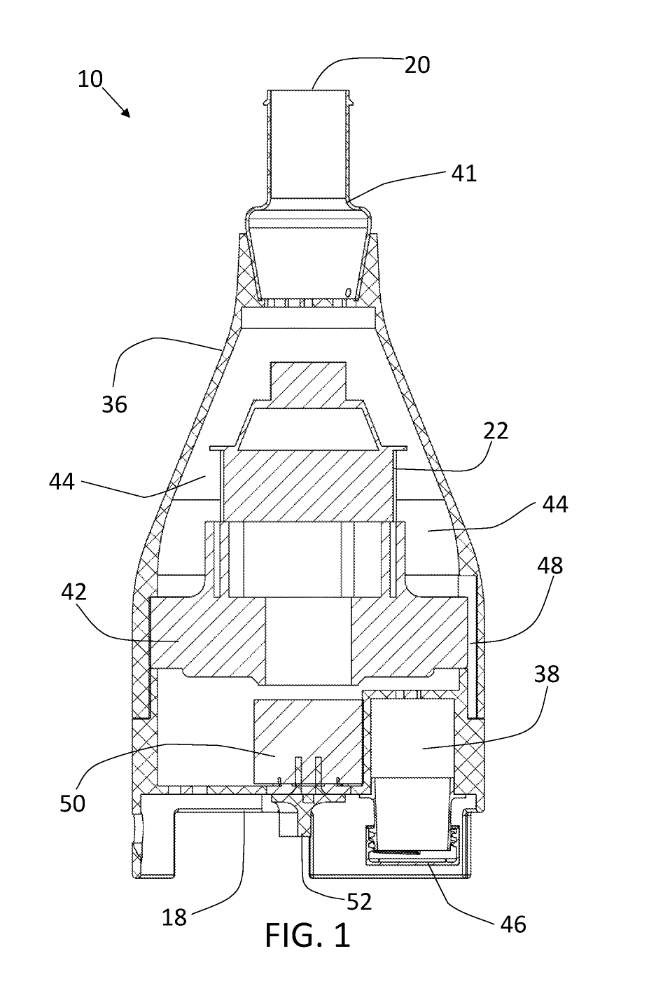

A forced air apparatus, generally identified by reference numeral 10, will now be described with reference to FIG. 1 through FIG. 5.

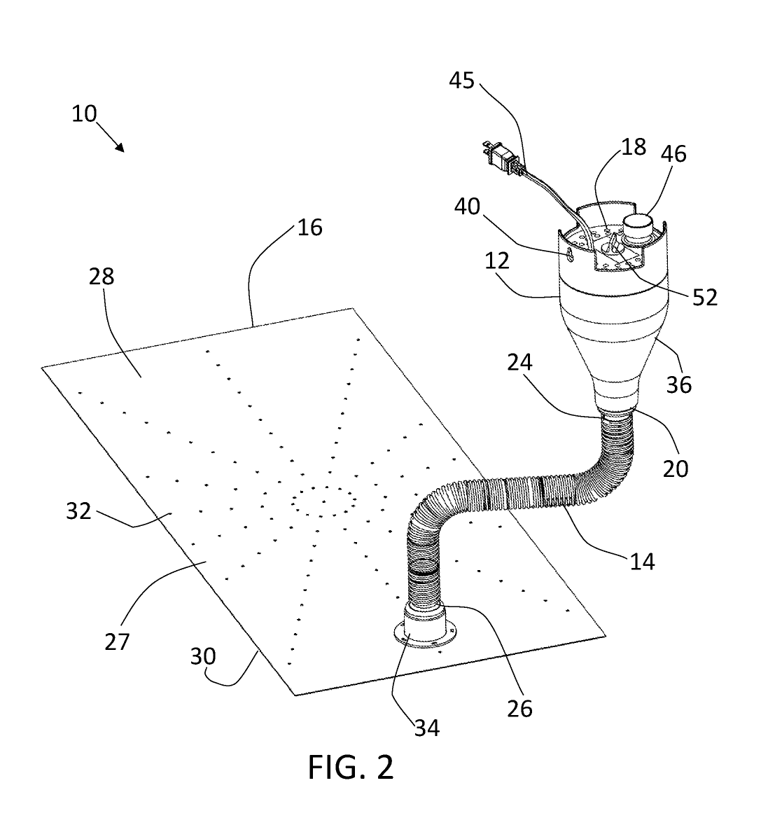

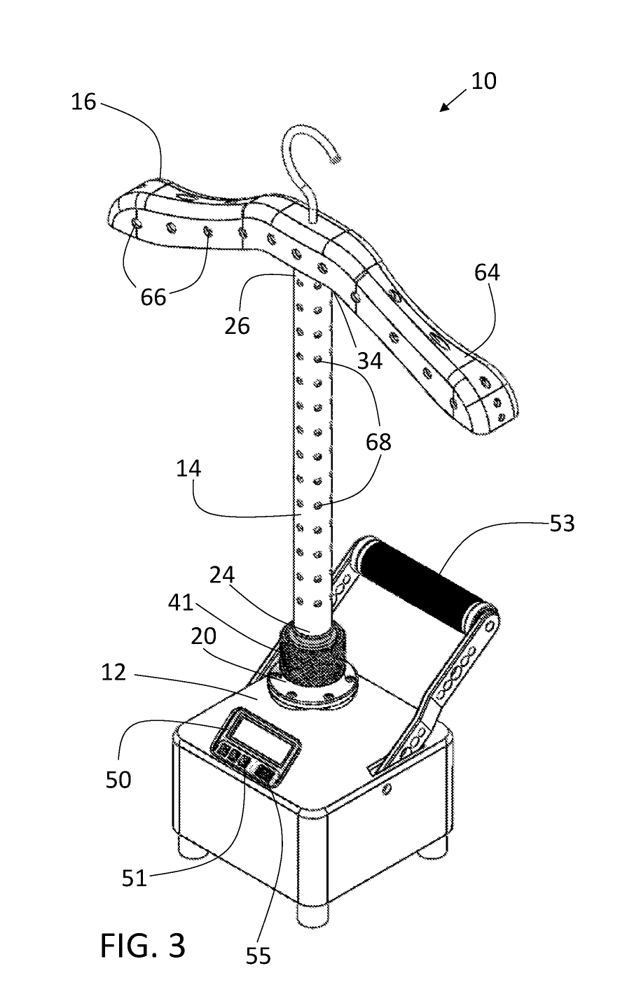

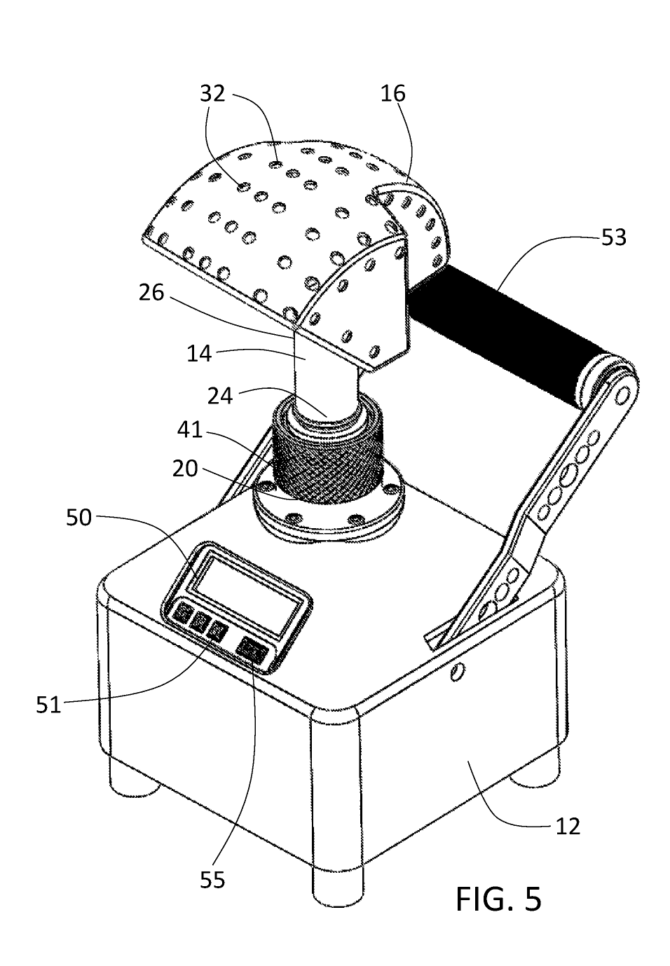

Referring to FIG. 2 through FIG. 5, a forced air apparatus 10 has an air blower 12, an air conduit 14 and a diffusion body 16. Referring to FIG. 1, air blower 12 has an air intake 18, an air outlet 20 and a blower motor 22. Referring to FIG. 2, FIG. 3 and FIG. 5, air conduit 14 has a first end 24 that is removable connectable to air outlet 20 of air blower 12 and has a second end 26 that is removable connectable to diffusion body 16.

Referring to FIG. 1, air blower 12 has an outer housing 36 which is preferably made of molded plastic. Molded plastic helps to keep air blower 12 from becoming hot to the touch, which may be useful in the prevention of fire due to overheating. It will be understood that outer housing 36 may be made of other suitable materials. Air blower 12 may be hung from a wall through the use of brackets around outer housing 36 or by using a hook, nail, screw or other hanging implement to hang air blower 12 using hanging aperture 40, shown in FIG. 2. It will be understood by a person skilled in the art that other methods of hanging air blower 12 are possible. Air outlet 20 has a quick connect 41 to allow for quick connection and disconnection of first end 24 of air conduit 14. A suction fan 42 is positioned within outer housing 36 and runs at approximately 28000 to 35000 rpms to pull air into air blower 12 through air intake 18. Suction fan 42 is operated by blower motor 22. Air channels 44 on the sides of blower motor 22 allow for the dissipation of excess heat. Blower motor 22 may be an electric motor that is connected to a power source with power cord 45. It will be understood that different power sources may be used such as batteries, solar power or any other suitable power source known in the art.

Air blower 12 has a treatment compartment 38 positioned near air intake 18. Treatment compartment 38 holds a material that treats the air flowing through air blower 12. Material that treats the air may include, but is not limited to, essential oils, deodorizers, antibacterial agents or any other suitable treatment. The materials that treat the air may be placed on a fabric pad, such as cotton or other suitable material. Using a fabric pad can make it easier to change out the material and can make clean up more simple Treatment compartment 38 has a cap 46 to allow for easy removal or replacement of treated material. A pressure channel 48 connects air channels 44 to treatment compartment 38 to direct air to travel from blower motor 12 to treatment compartment 38 prior to air flowing through air outlet 20.

Air blower 12 has a timer 50 for managing the amount of time blower motor 22 is running. Referring to FIG. 1 and FIG. 2, a timer dial 52 is used to set the amount of time timer 50 will run for. Referring to FIG. 3 and FIG. 5, timer 50 may be electronic. Referring to FIG. 1, timer 50 may be set up such that blower motor 22 is on while timer is active and is automatically turned off after a predetermined amount of time. This allows a user to turn on blower motor 22 for a set amount of time without requiring the user to remember to turn off blower motor 22. Air blower 12 may heat the air as it passes from air intake 18 to air outlet 20. Referring to FIG. 3 and FIG. 5, a temperature regulator 51 may be provided to allow a user to choose a predetermined temperature for heat. This heated and treated air may be used to dry, deodorize and remove bacteria from clothing and other items. Referring to FIG. 3 and FIG. 5, air blower 12 may have a handle 53 for easier transport. It will be understood that handle may be able to pivot in relation to air blower 12 or may be stationary.

Forced air apparatus 10 may be used for a number of different purposes. Forced air apparatus may be used for heating, drying or deodorizing rooms, buildings, tents and portable shelters. In these cases, diffusion body may be the rooms, buildings, tents or portable shelters and outlets may be windows, doors, vents or other outlets that allow for the egress of air. Forced air apparatus 10 may also be used for heating, drying or deodorizing clothing, sports equipment and other items. The type of diffusion body used is dependent upon the purpose of the user. It will be understood by a person skilled in the art that the diffusion bodies 16 described below may be used for purposes other than those specifically described and that other styles of diffusion bodies 16 may be used. Forced air apparatus 10 may also have usb ports 55 to allow for use with electronics. This allows forced air apparatus 10 to provide additional benefits when turned on. Emergency LED lights, not shown, may also be provided for additional benefit of the user.

Referring to FIG. 2, in the embodiment shown, diffusion body 16 is a diffusion mat 27. Diffusion mat 27 has a first surface 28, a second surface 30, a plurality of air outlets 32 and an air conduit connection 34 positioned on first surface 28. In the embodiment shown in FIG. 2, first surface 28 is the top surface and the second surface 30 is the bottom surface. It will be understood that first surface 28 may be the bottom surface and second surface 30 may be the top surface. The plurality of air outlets 32 allow air to flow between first surface 28 and second surface 30. Air conduit connection 34 allows for removable connection of second end 26 of air conduit 14. Air flowing from air blower 12 travels through air conduit 14 and air conduit connection 34 to beneath second surface 30 of diffusion mat 27. Air then travels from second surface 30 to first surface 28 through the plurality of air outlets 32. In the embodiment shown, air conduit 14 is flexible. It will be understood by a person skilled in the art that air conduit may be flexible or rigid.

Diffusion mat 27 may be placed in the bottom of a bag, such as a sports bag, or opposite the zipper side of the bag such that second surface 30 contacts the bag. It will be understood that diffusion mat 27 may be placed on top of clothing or other items or may be placed in any other suitable orientation that promotes air flow within the bag. When second surface 30 contacts the bottom of the bag, first surface 28 may have clothing or other items resting on it. Air conduit connection 34 is orientated away from second surface 30. Diffusion mat 27 may remain in the bag indefinitely or may be removed as needed for washing. Diffusion mat 27 may also be replaced in the event of damage. Second end 26 of air conduit 14 is removable connectable to air conduit connection 34. The length of air conduit 14 may vary depending upon the distance between air blower 12 and diffusion mat 27. Diffusion mat 27 is shown as being rectangular in shape, however it will be understood by a person skilled in the art that diffusion mat 27 may be any shape. Diffusion mat 27 is used to diffuse air flow throughout the bag in which it is placed. Diffusion mat 27 may be incorporated into a bag at the time of bag manufacturing. Diffusion mat 27 may also be used for other purposes such as bed warmers and drying mats. Diffusion mat 27 may also be used in conjunction with treated materials such as cinnamon and other materials known in the art that act to exterminate bed bugs and other bugs from a bed or surface. It will be understood by a person skilled in the art that diffusion mat may also be used for other purposes.

Referring to FIG. 3, in the embodiment shown, diffusion body 16 is a diffusion hanger 64. Diffusion hanger 64 is shaped like a clothing hanger and has a plurality of outlets 66 through which air may pass out of diffusion hanger 64. Diffusion hanger 64 may have an air conduit connection 34 that allows for removable connection of second end 26 of air conduit 14 from diffusion hanger. Air flowing from air blower 12 travels through air conduit 14 and air conduit connection 34 to diffusion hanger 64 where it is diffused through outlets 66. In the embodiment shown, air conduit 14 is rigid and provides support for diffusion hanger 64. A plurality of air outlets 68 allow air to flow from air conduit 14 to act upon material draped over diffusion hanger 64. Jerseys, protective sports gear, shirts, sweaters and other clothing like materials may be dried, heated or deodorized using the diffusion hanger from the inside out.

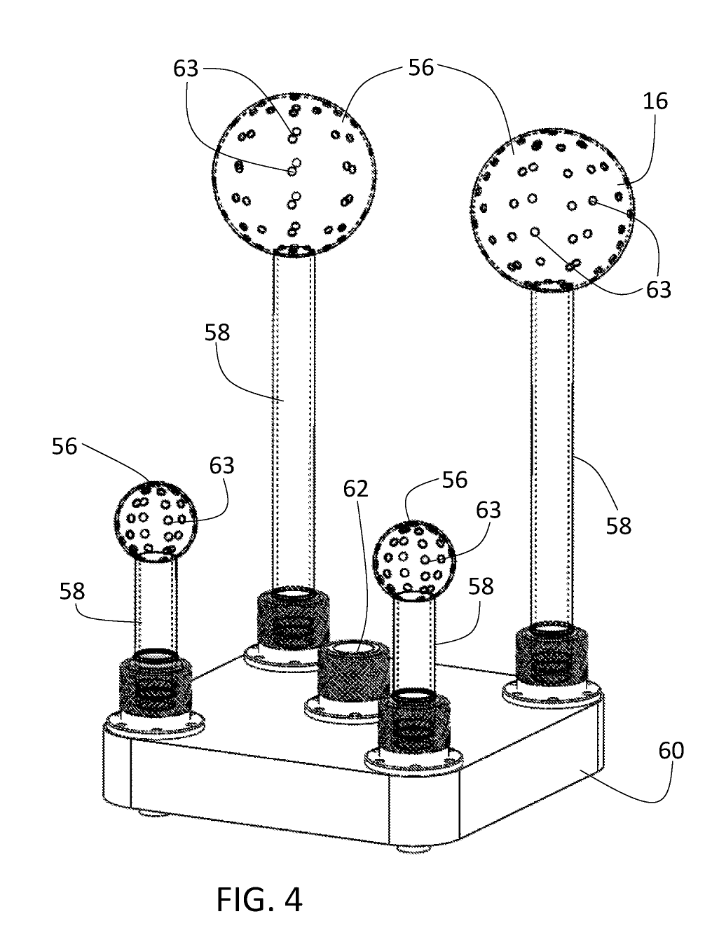

Referring to FIG. 4, in the embodiment shown, diffusion body 16 is a diffusion ball 56. In the embodiment shown, four diffusion balls 56 are supported by rigid air conduits 58 on a hollow base 60. Hollow base 60 has an air conduit connection 62 for connecting air conduit 14, shown in FIG. 2, to hollow base 60. Air travels from air blower 12, through air conduit 14, shown in FIG. 2, into hollow base 60. From hollow base 60, air travels through rigid air conduits 58 and into diffusion balls 56. Diffusion balls 56 have a plurality of air outlets 63 through which the air may pass out of diffusion balls 56. Diffusion balls 56 may be placed inside shoes, socks, gloves, sleeves of clothing, bags or any other suitable location to provide air for drying, heating or deodorizing as preferred. It will be understood that hollow base 60 is not required for use of a diffusion ball 56. Diffusion ball 56 may be attached to air conduit 14 in a similar manner as diffusion mat 27 and a flexible air conduit 14 may also be used.

Referring to FIG. 5, in the embodiment shown, diffusion body 16 is shaped such that it correlates to an interior surface of a sports helmet. A sports helmet, ball cap or other headgear may be placed on diffusion body 16. An air conduit connection 34, not shown, allows for removable connection of second end 26 of air conduit 14. Air flowing from air blower 12 travels through air conduit 14 and air conduit connection 34 to diffusion body 16 where air is diffused through a plurality of air outlets 32. Air conduit 14 is preferably rigid to provide support to diffusion body 16.

Any use herein of any terms describing an interaction between elements is not meant to limit the interaction to direct interaction between the subject elements, and may also include indirect interaction between the elements such as through secondary or intermediary structure unless specifically stated otherwise.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent that changes may be made to the illustrative embodiments, while falling within the scope of the invention. As such, the scope of the following claims should not be limited by the preferred embodiments set forth in the examples and drawings described above, but should be given the broadest interpretation consistent with the description as a whole.

What is claimed is:

1. A forced air apparatus, comprising:
an air blower having an air intake, an air outlet and a blower motor;
an air conduit having a first end and a second end, the first end being connectable to the air outlet of the air blower;
a diffusion body having an air conduit connection and at least one air outlet, the air conduit connection allowing for removable connection of the second end of the air conduit to the diffusion body such that air flows from the air blower to the diffusion body, the at least one air outlet allowing air to flow out of the diffusion body.

2. The forced air apparatus of claim 1 wherein the air blower has a treatment compartment for holding a material to treat the air flowing through the air blower.

3. The forced air apparatus of claim 1 wherein the air blower has a timer for managing the amount of time the blower motor is running.

4. The forced air apparatus of claim 3 wherein the timer automatically shuts off the blower motor after a predetermined amount of time.

5. The forced air apparatus of claim 2 where the air blower has a pressure channel to direct the air from the blower motor to the treatment compartment prior to the air flowing through the air outlet.

6. The forced air apparatus of claim 1 wherein the air blower heats the air as it passes from the air intake to the air outlet.

7. The forced air apparatus of claim 1 wherein the blower motor is electric and requires a power source.

8. The forced air apparatus of claim 7 wherein the power source is a rechargeable battery

9. The forced air apparatus of claim 1 wherein the diffusion body is a diffusion mat, the diffusion mat having a first surface, a second surface and a plurality of air outlets, the plurality of air outlets allowing air flow between the first surface and the second surface such that air flows from the air conduit to the second surface of the diffusion mat.

10. The forced air apparatus of claim 1 wherein the diffusion body is a diffusion hanger, the diffusion hanger being shaped like a clothing hanger and having a plurality of air outlets.

11. The forced air apparatus of claim 10 wherein the air conduit is rigid and has a plurality of air outlets to allow air to flow out of the air conduit to act upon material draped over the diffusion hanger.

12. The forced air apparatus of claim 1 wherein the diffusion body is a diffusion ball, the diffusion ball having a plurality of air outlets.

13. The forced air apparatus of claim 12 wherein the diffusion ball is supported by a rigid air conduit on a hollow base having an air conduit connection.

14. The forced air apparatus of claim 1 wherein the diffusion body is shaped such that it correlates to an interior surface of a sports helmet.

15. The forced air apparatus of claim 14 wherein the air conduit is rigid to provide support to the diffusion body.
